(19) United States
(12) Patent Application Publication
(10) Pub. No.: US 2002/0159008 A1
(43) Pub. Date: Oct. 31, 2002

(54) Color liquid crystal display device and method for manufacturing a color filter

(76) Inventors: Takeru Yoshino, Sayama-shi (JP); Kosei Miyabe, Kawagoe-shi (JP); Takakazu Yano, Tokyo (JP)

Correspondence Address: Finnegan Henderson Farabow Garrett & Dunner, 1300 I Street NW, Washington, DC, 20005-3315, US

(21) Appl. No.: 09/959,809

(22) PCT Filed: Mar. 9, 2001
(86) PCT No.: PCT/JP01/01882

(30) Foreign Application Priority Data
Mar. 10, 2000 (JP) 2000-067490

(51) Int. Cl. G02F 1/1335

(52) U.S. Cl. 349/106

(57) ABSTRACT

The present invention relates to a color liquid crystal display device which integrates a first partial display area (for example, an optional image display area) and a second partial display area (for example, a particular image display area) into one liquid crystal panel, and each having at least a different display specification, and has a different color filter pattern between the first partial display area and the second partial display area. In the present invention, for example, the color pitch of the color filter on the second partial display area is subdivided, rather than the color filter of the color filter on the first display area, such as into one-third, one-sixth and the like; each color of the color filter on the partial display area is provided in a zigzag arrangement or a delta arrangement; and the lead wire of each icon provided in the particular image display area is provided so as to be across each color of the color filter on the second partial display area. Further, it is possible to provide an improved manufacturing method of the color filter using the color liquid crystal display device.

### TECHNICAL FIELD

The present invention relates to a color liquid crystal display device and a method for manufacturing a color filter. In particular, in a liquid crystal panel having a plurality of partial display areas each having different contents of display, it relates to a liquid crystal display device and a method for manufacturing a color filter having a feature in which a color pattern of a color filter is used in each partial display area (pitch between each color).

### BACKGROUND ART

Recently, a color liquid crystal display device has been widely utilized in portable electronic equipment such as electronic notebooks, portable telephones and the like. The display device used in this equipment has two display types. That is, one type simultaneously displays different contents on a display, and the other type separately displays the different contents on the display. For example, the display device has a display area for displaying an optional image (below, “optional image display area”), and another display area for displaying only particular icons, picture-characters, or particular information (for example, time) (below, “particular image display area”). In this case, there are types either simultaneously displaying both display areas or only displaying one of the areas. As recent tendency, the optional image display area and the particular image display area are integrated on one liquid crystal panel as a partial display area, in order to realize a simplified circuit structure, compact equipment and the like.

In this case, in a color liquid crystal display device having an optional image display area and the particular image display area integrated as the partial display area on the liquid crystal panel, a color filter is needed in the liquid crystal panel.

Regarding a manufacturing method of the color filter, there are documents, for example, JPP-2-271301, which refer to the manufacturing method of the color filter used for the color liquid crystal panel. According to a method of manufacturing the color filter, a transparent colored photosensitive resin layer is formed on a base film in order to form a transcribed sheet, the transcribed sheet is transcribed on the substrate, and patterns on the photosensitive resin layer are exposed and developed. Further, regarding arrangement configuration of color pixels, there is another document, JPP-2-173784, which refers to the pixel arrangement of the color display in a matrix type display device. According to a display drive configuration in this document, one display line element is formed by two adjacent lines of the pixel, and two display line elements are formed by three adjacent lines.

However, the conventional arts, disclosed in the above documents, merely disclose a display method of a color liquid crystal, a manufacturing method of the color filter, arrangement configuration of color pixels and the like. That is, these documents do not disclose patterns of the color filter on each partial display area of the color liquid crystal display device which has an optional image display area and the particular image display area integrated as the partial display area on one liquid crystal panel. According to these conventional arts, the color filter is uniformly formed by the same pattern of the optional image display area and the particular image display area so that this structure includes a visual problem on the particular image display area as explained below.

### DISCLOSURE OF THE INVENTION

According to the first object of the present invention, there is provided a color liquid crystal device which holds a plurality of partial display areas within one liquid crystal panel, the pattern of the color filter on one partial display area being arranged so as to not always limit the pattern of the color filter on the other partial display area, the wiring of the electrodes to the color filter being improved, and the liquid crystal device having visually improved partial display area without unbalanced and blurred color.

Further, according to the second object of the invention, there is a method for manufacturing the color filter having a different pattern (in particular, a different color pitch) between partial display areas.

In order to realize the above object, according to a first aspect of the present invention, the invention is characterized in that the lead wire of the particular display pattern (for example, an icon) provided within the particular image display area is provided so as to be across each color of the color filter on the particular image display area.

According to a second aspect of the present invention, a color liquid crystal display device which integrates a first partial display area (for example, optional image display area) and a second partial display area (for example, particular image display area) into one liquid crystal panel, and each having at least a different display specification, is characterized in that the first partial display area and the second partial display area have different color filter patterns from one another.

As one embodiment, the invention is characterized in that a color pitch between each color of a color filter on the second partial display area is smaller than, or larger than, the color pitch of the color filter on the first partial display area.

As another embodiment, the invention is characterized in that, when the color pitch of the color filter on the first partial display area is “P”, and when the color pitch of the color filter on the second partial display area is “Q”, the color filter is formed by a relationship Q=P/n, or Q=P*n (where, n is a positive integer).

As still another embodiment, the invention is characterized in that, when the color pitch of the color filter on the first partial display area is “P”, when the color pitch of the color filter on the second partial display area is “Q”, and when the number of color of the color filter, the color filter is formed by a relationship Q=P/(m*n), or Q=P*m*n (where, n is a positive integer).

As still another embodiment, the invention is characterized in that the color pitch of the color filter on the first partial display area is “P”, and when the color pitch of the color filter on the second partial display area is “Q”, the color filter is formed by a relationship Q=P/(3*n), or Q=P*3*n (where, n is a positive integer).

As still another embodiment, the invention is characterized in that at least one of the color filters on the partial display area is formed by a zigzag arrangement or a delta arrangement between each color.

As still another embodiment, the invention is characterized in that an overlapping portion between adjacent color filters on the first partial display area and an overlapping portion between adjacent color filters on the second display area are different one another in an overlapping amount.

As still another embodiment, the invention is characterized in that the first partial display area and the second partial display area are provided on one display area.

As still another embodiment, the invention is characterized in that the color filter on the first partial display area and the color filter on the second partial display area are formed so as not to occur a gap one another.

As still another embodiment, the invention is characterized in that color arrangement on the first display area is “C1C2C3”, color arrangement on the second partial display area is “C1C3C2C2C1C3C3C2C1”.

As still another embodiment, the invention is characterized in that when color arrangement on the first display area is “C1C2C3”, color arrangement on the second partial display area is “C1C3C1C2C1C2C3C2C3”.

According to a third embodiment of the present invention, there is provided a method for manufacturing a color filter in a color liquid crystal display device which integrates a first partial display area and a second partial display area into one liquid crystal panel, and each having at least a different display specification, and which has a different color filter pattern between the first partial display area and the second partial display area, characterized by steps of using one color mask for simultaneously exposing the same color portion between the color filter on the first partial display area and the color filter on the second partial display area; exposing each color portion by shifting the color mask for each color; and manufacturing the color filter on the first and second partial display areas.

As still another embodiment, the invention is characterized in that the color filter on the first partial display area and the color filter on the second partial display area are formed by three colors of R, G, B, and by exposing three times using the same color mask, the color filter on the first and second partial display areas is manufactured.

As still another embodiment, the invention is characterized in that, in the color mask, when the color pitch of the color filter on the first partial display area is “P”, the pattern having approximately width “P” is provided for each pitch 3P on an area corresponding to the first partial display area; the three patterns each having approximately width P/3 are provided in each 3P width of the area corresponding to the color filter on the second partial display area; after completion of exposure for a first color using the color mask; performing the exposure corresponding to a second color by shifting the color mask by “P”; and performing the exposure corresponding to a third color by shifting the color mask by “P”; and the color filter on the first and second partial display areas is manufactured.

As still another embodiment, the invention is characterized in that, in the color mask, there is no gap between an area in which the pattern for the color filter on the first partial display area, and an area in which the pattern for the color filter on the second partial display area.

### BRIEF EXPLANATION OF THE DRAWINGS

FIG. 1 is an essential structural view of a color filter on a particular image display area according to one embodiment of the present invention.

FIG. 2 is a structural view of the color filter according to another embodiment of the present invention.

FIG. 3 is a structural view of the color filter according to still another embodiment of the present invention.

FIG. 4 is a view of the color filter according to still another embodiment of the present invention, (A) shows one example of the color filter having narrow pitch between colors, (B) shows another example of the color filter having segmented structure, and (C) shows still another example of the color filter having a zigzag arrangement or a delta arrangement.

FIG. 5 is an essential explanatory view of the color filter when manufacturing the color filter according to the present invention.

FIG. 6 shows one example of the color filter manufactured by a step in FIG. 5.

FIG. 7 is an essential structural view of the color liquid crystal display device using the color filter according to the present invention.

FIG. 8 is an essential cross-sectional view of the color liquid crystal display device using the color filter according to the present invention.

FIG. 9 is an essential structural view of the color filter including a particular image display area and an optional image display area in a conventional art.

### BEST MODE OF CARRYING OUT THE PRESENT INVENTION

The embodiments of the present invention will be explained with reference to the drawings below. In the explanations, the optional image display area used as the first partial display area shows a matrix pattern portion, which is driven with time-sharing operation, and the particular image display area used as the second partial display area shows a fixed pattern portion which is driven with static operation.

Before explaining the present invention, a conventional structure and its problem will be explained below.

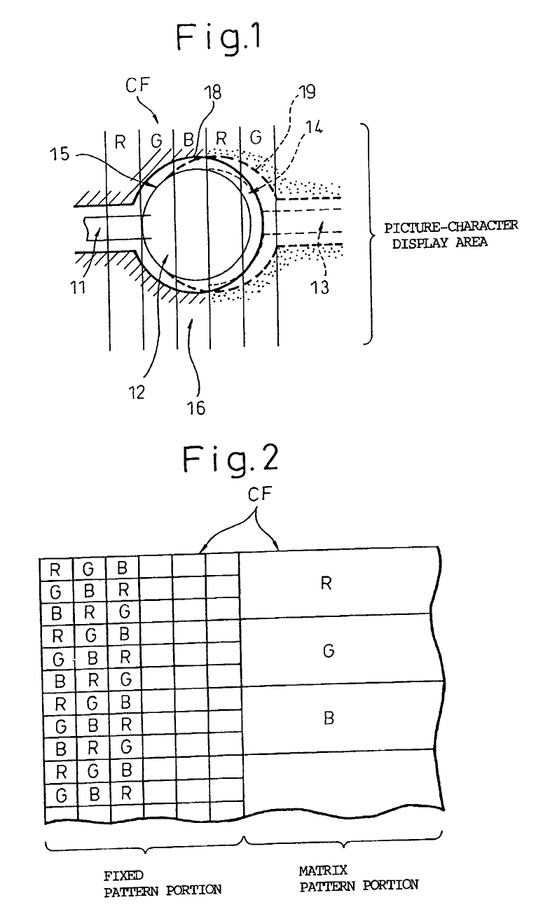

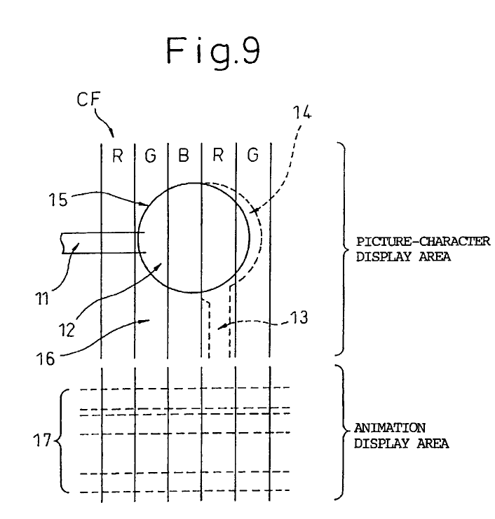

FIG. 9 is the essential structural view of the color filter including the particular image display area and the optional image display area in the conventional art. In the drawing, number 11 is a lead wire for common electrode (first substrate electrode) used for the particular image display, number 12 is an common electrode used for the particular image display, number 13 is a lead wire for segment electrode (second substrate electrode) used for the particular image display, number 14 is a segment electrode used for the particular image display, number 15 is an icon on the common electrode for the particular image display, number 16 is a peripheral portion, number 17 is a first substrate electrode on the optional image display area (matrix pattern portion), and CF is a color filter. The lead wire 13 for the segment electrode used for the particular image display, as shown in the drawing, is linearly arranged along with the pattern of the color filter on the R (red) color filter. As shown in FIG. 1, in the peripheral portion of the common electrode 12 for the particular image display and the lead wire 11, a background common electrode 18 is provided in order to drive the background portion. Further, in the peripheral portion of the segment electrode 14 for the particular image display and the lead wire 13, a background segment electrode 19 is provided in order to drive the background portion.

In the structure of the particular image display area, color-unevenness occurs in the peripheral portion of the icon 15, and the color-unevenness may be visually noticeable. This noticeable portion becomes remarkable in the case of color display on the particular image display area. The reason will be explained below.

In the liquid crystal display panel, in general, a white color is displayed when the sufficient voltage is supplied between opposite electrodes in which the liquid crystal is held between them, and the black color is displayed when the sufficient voltage is not supplied between them. This type is called “normally-black type”. On the other hand, the black color is displayed when the sufficient voltage is supplied between opposite electrodes, and the white color is displayed when the sufficient voltage is not supplied between them. This is called “normally-white type”. Accordingly, the reason of the color-unevenness will be explained for the above two types.

(1) In the Case of the Normally-black Type

When the peripheral portion 16 of the background of the icon 12 is white due to the supply of the voltage, the icon 15 becomes white when the voltage is supplied to the icon 15. Further, the voltage is supplied to the lead wire 13 and the lead wire 13 is colored by the R (red) of the color filter. As a result, since the lead wire 13, which is colored by the red, is displayed on the white background, color-unevenness becomes visually noticeable.

(2) In the Case of the Normally-white Type

When the peripheral portion 16 of the background of the icon 12 is black due to the supply of the voltage, the icon 15 becomes white when the voltage is not supplied to the icon 15. Further, the voltage is not supplied to the lead wire 13 and the lead wire 13 becomes white. However, since the lead wire 13 is provided on the R (red) of the color filter, the lead wire 13 is colored by the R (red). As a result, since the background is black and the lead wire 13 is colored by the red, color-unevenness becomes visually noticeable.

As explained above, in the conventional art, even if the background is either white or black when the voltage is supplied thereto, the lead wire 13 becomes visually noticeable.

The first aspect of the present invention aims to resolve visually noticeable portion due to the lead wire, as explained below.

FIG. 1 is the essential structural view of the color filter on the particular image display area according to one embodiment of the present invention. As well as FIG. 9, number 11 is the lead wire for a common electrode (first substrate electrode) used for the particular image display, number 12 is the common electrode used for the particular image display, number 13 is the lead wire for segment electrode (second substrate electrode) used for the particular image display, number 14 is the segment electrode used for the particular image display, number 15 is the icon on the common electrode for the particular image display, number 16 is peripheral portion of the icon, number 17 is the first substrate electrode on the optional image display area (matrix pattern portion), CF is the color filter, number 18 is the background common electrode, and number 19 is the background segment electrode. The optional image display area is omitted in this drawing.

In the present invention, as shown in the drawing, the lead wire 13 for the segment electrode used for the particular image display is provided so as to be across each color of R, G, B of the color filter CF. As explained above, since the lead wire 13 for the segment electrode used for the particular image display is provided so as to be across each color of the color filter, even if the background either white or black when the voltage is supplied thereto, the visually noticeable portion of the lead wire 13 can be reduced as explained below. In this example, since the lead wire 3 is provided so as to be across the color filter, it is possible to realize the same effect even if the lead wire 13 is provided so as to be diagonally across the color filter, as explained in detail below.

(a) In the Case of the Normally-black Type

In the case of FIG. 9, as mentioned in item (1), when the peripheral portion 16 of the background of the icon 12 is white due to the supply of the voltage, the icon 15 becomes white, and the voltage is supplied to the lead wire 13 and the lead wire 13 is colored by the R (red) of the color filter. As a result, the lead wire 13 becomes visually noticeable.

However, according to the present invention shown in FIG. 1, since the lead wire 13 is provided so as to be across each color (R, G, B) of the color filter, the lead wire 13 appears to be colored by white on the whole so that it is possible to resolve a visually noticeable portion for the white background.

(b) In the Case of the Normally-white Type

In the case of FIG. 9, as mentioned in item (2), when the peripheral portion 16 of the background of the icon 15 is black due to the supply of the voltage, the icon 15 becomes white when the voltage is not supplied, and the lead wire 13 is colored by the white. In this case, since the lead wire 13 is provided on the R color filter, the lead wire 13 is colored by the red. As a result, since the background is black and the lead wire 13 is red, the lead wire 13 becomes visually noticeable.

However, according to the present invention shown in FIG. 1, since the lead wire 13 is provided so as to be across each color (R, G, B) of the color filter, the lead wire 13 appears to be colored by the white so that it is possible to resolve visually noticeable portion for the white background.

Next, a pitch of the color filter and color-unevenness on the particular image display area will be explained below. For example, in the normally-black type liquid crystal display device having the color filter formed of three colors of R, G, B, it is assumed that the white icon is displayed on the particular image display area. In this case, it is necessary to simultaneously turn on the three colors of R, G, B, in order to display the white. However, when the color pitch of the color filter is not sufficiently fine between each color, the mixed color of the RGB becomes insufficient in the vicinity of the profile of the icon to be displayed. As a result, unbalanced or blurred color occurs in the vicinity of the profile of the icon. This phenomena becomes noticeable when the icon to be displayed becomes smaller.

FIG. 2 is a structural view of the color filter according to another embodiment of the present invention. In this example, the color pitch (p) of the color filter on the particular image display area (fixed pattern portion) is subdivided into one-third (⅓) for the color pitch of the color filter on the optional image display area (matrix pattern portion). Accordingly, the icon on the particular image display area can be finely displayed as three times the optional image display area.

As mentioned above, the color filter according to the present invention has different color pitches between the particular image display area and the optional image display area. In comparison with the conventional structure shown in FIG. 9, i.e., the color pitch of the particular image display area (fixed pattern portion) being the same color pitch of the optional image display area (matrix pattern potion), the structure of FIG. 2 can improve “mixed-color characteristic” in the peripheral portion of the icon on the pattern portion of the particular image display. Further, it is possible to resolve unbalanced color and blurred color, and to display the icon of the still image in visually favorable condition. That is, as mentioned above, since the present invention has the color pitch subdivided into one-third, an edge portion of the icon becomes smooth on the particular image display area, so that it is possible to realize visually favorable icon.

The above explanations are provided for the fixed pattern portion in which the particular image display area is statically driven. Although it is possible to realize very high contrast in this condition, the color of the icon to be displayed is limited to either the white or the black. Accordingly, when a user intends to display the icon using an optional color, the particular image display area should be the matrix pattern matched with the pitch of the color filter, not the fixed pattern. This method, however, is not always preferable when displaying the icon based on any one of single color (for example, R, G, B) structuring the color filter. For example, when displaying the R (red) icon using the RGB matrix pattern, the light amount used for display is limited to the light amount only passed through the R filter, and the light amount from the G and B filters is zero. That is, since the turning-on area becomes one-third, the brightness is reduced. Accordingly, it is necessary to consider possibility of employment of another structure.

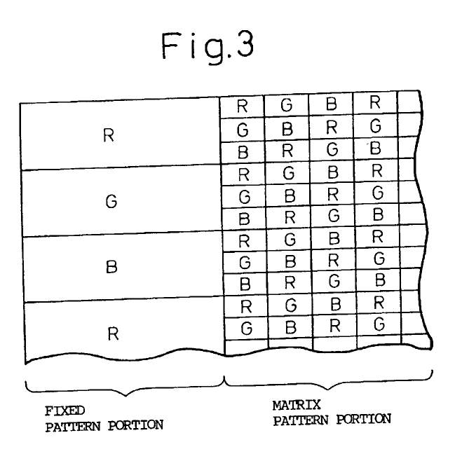

FIG. 3 is a structural view of the color filter according to still another embodiment of the present invention. In FIG. 3, the color pitch of the color filter on the particular image display area is shown as three times the color pitch of the color filter CF on the matrix pattern portion. It is not limited to three times, and can be set to optional magnification. Further, the width of the color filter can be set to different widths for each color. Further, the color filter on the particular image display area can be set to only a single color. Further, the icon display portion can be set to the particular color pattern, and the background can be set to another color pattern. Further, it is desirable to set the particular image display area to the fixed pattern portion as shown in FIG. 3, and to statically drive the particular image display area.

According to FIG. 3, it is possible to finely display the color for the optional image display area with reference to the particular image display area. Further, on the particular image display area, it is possible to clearly display the single color having a clear profile without the brightness for the icon being displayed within any single filter area.

In the case that the both color filters for the optional image display area and the particular image display area are linearly formed (FIGS. 2 and 3), although the color pitch of one color filter is set to one-third for the other color pitch, it is not limited to one-third, and can be set to optional relationship. In this case, when actually preparing the color mask, it is easy to prepare the color mask when the color pitch of one color filter is set to n-times (“n” is integer). Further, there is an advantage for simplifying a problem of overlap between adjacent color filters as mentioned below.

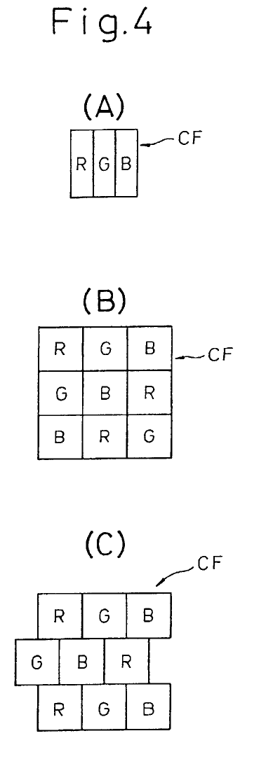

FIG. 4 is the view of the color filter according to still another embodiment of the present invention. (A) shows one example of the color filter having narrow pitch between colors. (B) shows another example of the color filter having the subdivided pattern into longitudinal direction, and corresponding to the color filter on the pattern portion of the particular image display shown in FIG. 2. (C) shows still another example of the color filter having a zigzag arrangement or a delta arrangement similar to the structure of (B).

In the case of (B), although the pattern of (A) is subdivided into one-third in the longitudinal direction, it is not limited to one-third, and it is possible to subdivide the pattern into one-Nth (where, N is positive integer). In the case of (B), since the pixel arrangement of R, G, B is a zigzag on the upper, middle, and lower layer, and since the upper and lower pixels and the left and right pixels are not set to the same color as one another, it is possible to improve the “mixed-color characteristic” compared to the structure of (A).

In the case of (C), the pixel arrangement of R, G, B is a zigzag on the upper, middle, and lower layer, and each pixel of R, G, B is arranged in a delta configuration. According to the delta arrangement, since any pixel positioned on adjacent upper and lower pixels, left and right pixels, pixels located on diagonal direction, are not the same color, it is possible to improve the “mixed-color characteristic” compared to the structure of (B).

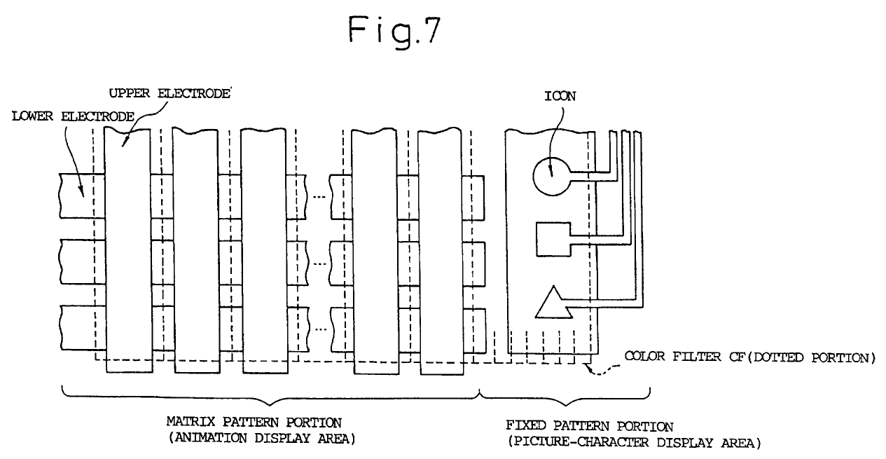

FIG. 7 is the essential structural view of the color liquid crystal display device using the color filter according to the present invention. In this example, the optional image display is used as an animation display area, and the particular image display area is used as a picture-character display area. In FIG. 7, the area shown by dotted lines is the color filter. In this example, the color filter has a structure in which the color pitch of the color filter on the fixed pattern portion (picture-character display area) is set to a narrow pitch compared to the color pitch of the color filter on the matrix pattern (animation display area) as shown in FIG. 2.

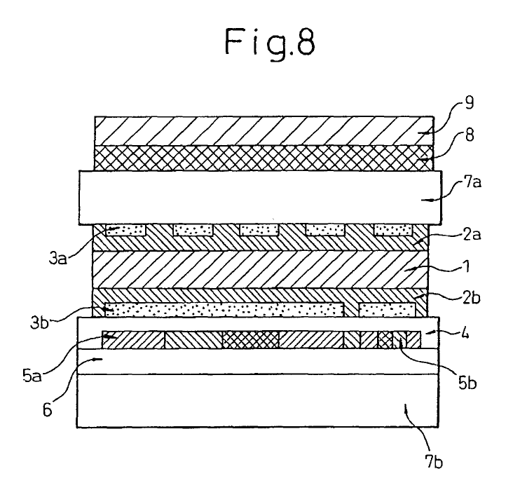

Further, FIG. 8 is the essential cross-sectional view of the reflection type-color liquid crystal display device using the color filter, according to the present invention, which uses a reflection board. In FIG. 8, number 1 is a liquid crystal member; numbers 2a and 2b are upper and lower alignment films; numbers 3a and 3b are upper and lower electrodes; number 4 is a protection film; and numbers 5a and 5b color filters. In this example, the color filter 5a is applied to the optional image display area, and the color filter 5b is applied to the particular image display area. The protection film 4 is a coating material (overcoat) for protecting the surface of the color filter. Further, number 6 is a reflection board; numbers 7a and 7b are upper and lower glass plates; number 8 is a phase difference correcting board, and number 9 is a polarization board. Since this example is the reflection type, the color filter is arranged to the position shown in the drawing. In the case of a transmission type-color liquid crystal display device (not shown), the lower reflective board of the color filter is removed, and, usually, a backlight (not shown) is provided.

On the other hand, when manufacturing the color filter, the adjacent color filters are overlapped (partially overlapped) on one another between adjacent color filters, in order to avoid transmission of unnecessary light through a gap. Accordingly, the partially thick portions occur repeatedly on the color filter. In this situation, when coating the protection film 4 of FIG. 8 on the color filter using a spinner, the protection film becomes thick on the narrow portion of the pitch of the color filter, and the gap of the liquid crystal layer becomes non-uniform, so that the quality of the image becomes worse.

Accordingly, in another embodiment of the present invention, the width of the overlapped portion, which is structured by a narrow pitch between adjacent color filters, is set to a width narrower than the overlapped portion which is structured by a wide pitch between adjacent color filter. According to this structure, the difference of the protection film between the narrow portion of the pitch and the wide portion of the pitch in the color filter becomes small, and the gap of the liquid crystal layer becomes approximately uniform so that it is possible to improve the quality of the image.

In the embodiment of the present invention, particular color masks are provided for each color which forms the color filter, and the arrangement of the color mask and exposure are sequentially repeated, so that the color filter of the particular image display area and color filter of the optional image display area are prepared. In this case, however, it is possible to reduce the number of color mask.

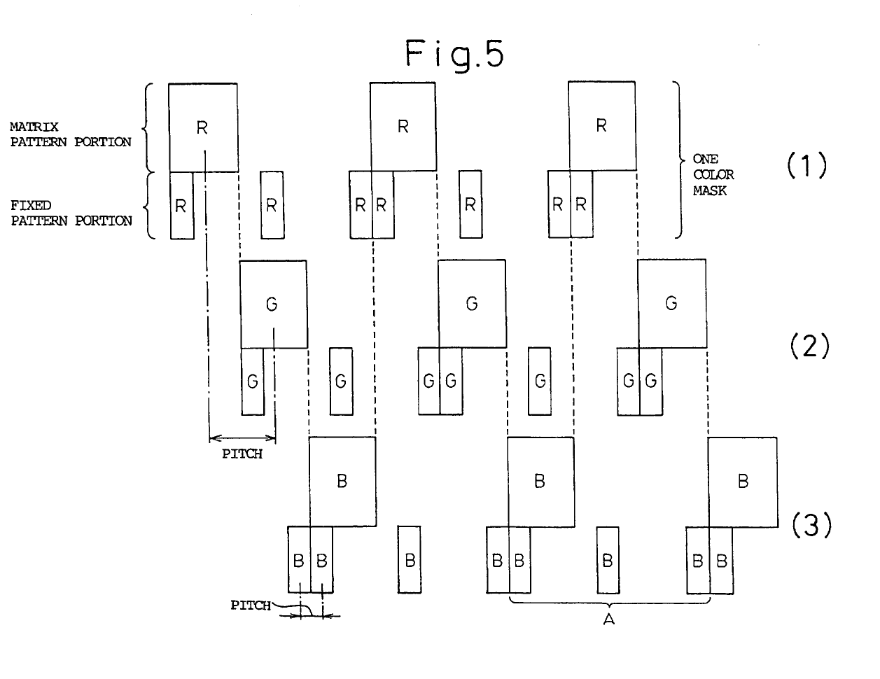

As shown in FIG. 5, using one color mask including the matrix pattern portion indicating the first display area or the optional image display area and the fixed pattern portion indicating the second display area or the particular image display area it is possible to prepare the complete RGB color filter through the following steps.

Here, the color pitch of the color filter on the matrix pattern portion is shown by “P”.

(1) First, the R portion is exposed by using the color mask.

(2) Next, the G portion is exposed by shifting the color mask by the pitch “P” in the right direction.

(3) Further, the B portion is exposed by further shifting the color mask by the pitch “P” in the right direction.

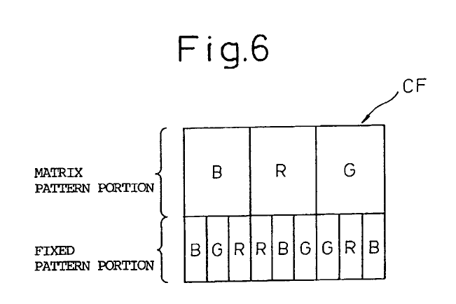

According to the above steps, in the area A in FIG. 5, the color filter having the color arrangement “BRG” and color pitch “P” is formed on the matrix pattern portion (optional image display are) as shown in FIG. 6, and the color filter having the color arrangement “BGRRBGGRB” and P/3 color pitch is formed on the fixed pattern portion (particular image display area).

It is assumed that the color pitch of the color filter on the optional image display area is “P”, the color pitch of the color filter on the particular image display area is “Q”, and the number of color the color filter is “m”. In this case, in general, it is necessary to have the relationship Q=P/(m*n), in order to prepare the complete color filter using one color mask. Where, “m” and “n” are positive integers. When the color filter is three colors of R, G, B, the relationship becomes Q=P/(3*n). In this case, when “n” becomes larger, it is possible to subdivide the color pitch of the pattern portion for the particular image display, and to resolve the visually unbalanced and blurred color. When “m” is 3, and “n” is 1, the relationship becomes Q=P/3, and this corresponds to the case of FIG. 6.

It is possible to prepare approximately the same color filter shown in FIG. 6 by using one color mask having the patterns different from the color mask shown in FIG. 5. That is, it is assumed that a bit is set to “1” when there is the pattern, and the bit is set to “0” when there is no pattern, for each pitch P/3. The pattern arrangement corresponding to the fixed pattern portion (particular image display area) of the color mask shown in FIG. 5 can be expressed by repetition of “100010001”. When changing this pattern to repetition of “101010000”, the color arrangement of the color filter on the fixed pattern portion (particular image display area) in FIG. 6 is changed from “BGRRBGGRB” to “BGBRBRGRG”. In the former case, there is continuation of same color such as “BB”, “RR”, “GG”. In the latter, however, there is no continuation of same color so that it is possible to improve the “mixed-color characteristic”.

According to general expression, when the color arrangement of the color filter on the first partial display area is “C1C2C3”, the color arrangement of the color filter on the second partial display area is “C1C3C2C2C1C3C3C2C1” in the case of the former, and is “C1C3C1C2C1C2C3C2C3” in the case of the latter.

Possibility of Utilization on Industry

According to the present invention, the color liquid crystal display device includes the structure which injects the liquid crystal between the first substrate and the second substrate, and which integrates the first partial display area (for example, optional image display area) and the second partial display area (for example, particular image display area) to one display area, and each area having at least different display specification. The lead wire of the of the fixed pattern on the particular image display area is provided so as to be across the color filter on the particular image display area. Since the color pitch of the color filter on the first partial display area is different from the color pitch of the color filter on the second partial display area, it is possible to resolve unbalanced color or blurred color on the particular image display area, and to realize a visually favorable display of an icon. As a result, it is possible to provide visually favorable color liquid crystal display device. Further, since a method for manufacturing the color filter using the color liquid display device is improved, it is possible to effectively manufacture a color filter so that the possibility of utilization on the industry is large in various fields.

1. A color liquid crystal display device which integrates a first partial display area and a second partial display area into one liquid crystal panel, and each having at least a different display specification, characterized in that the first partial display area and the second partial display area have different color filter patterns to one another.

2. A color liquid crystal display device as claimed in claim 1 wherein a color pitch between each color of a color filter on the second partial display area is smaller than, or larger than, the color pitch of the color filter on the first partial display area.

3. A color liquid crystal display device as claimed in claim 2 wherein, when the color pitch of the color filter on the first partial display area is “P”, and when the color pitch of the color filter on the second partial display area is “Q”, the color filter is formed by a relationship Q=P/n, or Q=P*n (where, n is a positive integer).

4. A color liquid crystal display device as claimed in claim 2 wherein, when the color pitch of the color filter on the first partial display area is “P”, when the color pitch of the color filter on the second partial display area is “Q”, and when the number of color of the color filter is “m”, the color filter is formed by a relationship Q=P/(m*n), or Q=P*m*n (where, n is a positive integer).

5. A color liquid crystal display device as claimed in claim 2 wherein the color pitch of the color filter on the first partial display area is “P”, and when the color pitch of the color filter on the second partial display area is “Q”, the color filter is formed by a relationship Q=P/(3*n), or Q=P*3*n (where, n is a positive integer).

6. A color liquid crystal display device as claimed in any one of claims 1 to 5, wherein at least one of the color filters on the partial display area is formed by a zigzag arrangement or a delta arrangement between each color.

7. A color liquid crystal display device as claimed in any one of claims 1 to 6 wherein an overlapping portion between adjacent color filters on the first partial display area and an overlapping portion between adjacent color filters on the second display area are different from one another in an overlapping amount.

8. A color liquid crystal display device having a first partial display area and a second partial display area, and each having different display specification, characterized in that a lead wire of each particular pattern electrode provided on the second partial display area is provided so as to be across each color of the color filter on the second partial display area.

9. A color liquid crystal display device as claimed in any one of claims 1 to 8 wherein the first partial display area and the second partial display area are provided on one display area.

10. A color liquid crystal display device as claimed in claim 9 wherein the color filter on the first partial display area and the color filter on the second partial display area are formed so as not to occur a gap one another.

11. A color liquid crystal display device as claimed in any one of claims 1 to 10 wherein when color arrangement on the first display area is “C1C2C3”, color arrangement on the second partial display area is “C1C3C2C2C1C3C3C2C1”.

12. A color liquid crystal display device as claimed in any one of claims 1 to 10 wherein when color arrangement on the first display area is “C1C2C3”, color arrangement on the second partial display area is “C1C3C1C2C1C2C3C2C3”.

13. A method for manufacturing a color filter in a color liquid crystal display device which integrates a first partial display area and a second partial display area into one liquid crystal panel, and each having at least different display specification, and which has a different color filter pattern between the first partial display area and the second partial display area, characterized by steps of using one color mask for simultaneously exposing the same color portion between the color filter on the first partial display area and the color filter on the second partial display area; exposing each color portion by shifting the color mask for each color; and manufacturing the color filter on the first and second partial display areas.

14. A method for manufacturing a color filter in a color liquid crystal display device as claimed in claim 13 wherein the color filter on the first partial display area and the color filter on the second partial display area are formed by three colors of R, G, B, and, by exposing three times using the same color mask, the color filter on the first and second partial display areas is manufactured.

15. A method for manufacturing a color filter in a color liquid crystal display device as claimed in claim 13 or 14 wherein, in the color mask, when the color pitch of the color filter on the first partial display area is “P”, the pattern having approximately width “P” is provided for each pitch 3P on an area corresponding to the first partial display area; the three patterns each having approximately width P/3 are provided in each 3P width of the area corresponding to the color filter on the second partial display area; after completion of exposure for a first color using the color mask; performing the exposure corresponding to a second color by shifting the color mask by “P”; and performing the exposure corresponding to a third color by shifting the color mask by “P”; and the color filter on the first and second partial display areas is manufactured.

16. A method for manufacturing a color filter as claimed in any one of claims 13 to 15 wherein, in the color mask, there is no gap between an area in which the pattern for the color filter on the first partial display area is arranged, and an area in which the pattern for the color filter on the second partial display area is arranged.
